(19) United States
(12) Patent Application Publication
(10) Pub. No.: US 2023/0390765 A1
(43) Pub. Date: Dec. 7, 2023

(54) MICROCHANNEL DEVICE AND METHOD FOR PRODUCING THEREOF

(71) Applicant: CANON KABUSHIKI KAISHA, Tokyo (JP)

(72) Inventors: AKIHISA MATSUKAWA, Tokyo (JP); MAKOTO FUKATSU, Shizuoka (JP); MASANORI TANAKA, Kanagawa (JP); TAKESHI YAMAMOTO, Kanagawa (JP); Keiji Miyazaki, Tokyo (JP); JUN MIURA, Kanagawa (JP); HARUNOBU MAEDA, Tokyo (JP); FUKA ENOKIDO, Kanagawa (JP); YUHEI TERUI, Shizuoka (JP)

(21) Appl. No.: 18/453,901

(22) Filed: Aug. 22, 2023

Related U.S. Application Data
(63) Continuation of application No. PCT/JP2022/007003, filed on Feb. 21, 2022.

(30) Foreign Application Priority Data
Feb. 25, 2021 (JP) 2021-028797

(51) Int. Cl. B01L 3/00

(52) U.S. Cl. CPC B01L 3/502707

(57) ABSTRACT

It is possible to provide a microchannel device with excellent resistance to bending and suppressed deterioration in inspection accuracy. A microchannel device has a channel sandwiched between channel walls formed in an inside a porous substrate, the channel wall contains a thermoplastic resin and a wax, and a proportion of the wax in an area of a surface side of the channel wall facing the channel is higher than a proportion of the wax inside the channel wall.

### CROSS-REFERENCE TO RELATED APPLICATIONS

This application is a Continuation of International Patent Application No. PCT/JP2022/007003, filed Feb. 21, 2022, which claims the benefit of Japanese Patent Application No. 2021-028797, filed Feb. 25, 2021, both of which are hereby incorporated by reference herein in their entirety.

### BACKGROUND OF THE DISCLOSURE

### Field of the Disclosure

The present disclosure relates to a microchannel device that is formed in the inside of a porous substrate and method for producing thereof.

### Description of the Related Art

In recent years, the development of a microchannel device that can efficiently (in trace amount, quickly and simply) perform an analysis in biochemistry in one chip, with the use of a fine channel of a micro size, has been attracting attention in a wide range of fields. Specifically, the development of microchannel device has been attracting attention not only in biochemistry research but also in various fields such as biochemical research, medical care, drug discovery, health care, environment and foods. Among the microchannel devices, a paper micro-analysis chip based on paper has advantages of light weight and low cost compared with conventional devices, has no need of using a power source, and also has high disposability. For this reason, the paper micro-analysis chip is expected to serve as an inspection device for medical activities in developing countries and remote areas where medical facilities are not well arranged and in disaster sites, and for airports and the like where the spread of infectious diseases must be stopped at the water's edge. In addition, the paper micro-analysis chip is attracting attention also as a health care device that can manage and monitor one's own health condition, because of being inexpensive and easy to handle.

In the early 1990s, a micro-analysis chip was developed that had a fine channel of a micro size formed on glass or silicon with the use of a photolithography method, a mold or the like, and carried out pretreatment, stirring, mixing, reaction and detection of a sample, on one chip. As a result, the micro-analysis chip realized miniaturization of the inspection system, quick analysis, and the reduction of a specimen, a reagent and a waste liquid. However, though the microchannel produced with the use of these photolithography technologies has high accuracy, the production cost thereof becomes very high, and because of being difficult to incinerate, the disposability thereof becomes low. In addition, when an inspection liquid is sent into the microchannel, an auxiliary apparatus such as a syringe pump is necessary; accordingly, the use of the microchannel is limited to an environment in which facilities are arranged; and the microchannel has been mainly used in research institutions of biochemical systems.

Though there have been these problems, the paper micro-analysis chip uses an inexpensive material such as paper or cloth as a substrate, also can drive a specimen or the inspection liquid by utilizing a capillary phenomenon of the material itself, and can be used at low cost and in a non-electric environment. In addition, transportation (distribution) is easy, and the disposability is high (disposal is completed only by burning). Furthermore, the apparatus does not need maintenance, and accordingly, it becomes possible to easily realize diagnosis by POC (point of care) at a low cost, by anyone (even an elderly person or a child having no knowledge), and in any place (regardless of a place including a place where there is no power source). Therefore, research and development of paper micro-analysis chips for various infectious diseases, specific diseases, and health care (chronic disease management, health management) are currently being carried out by research institutions in the world.

Since micro-channel devices use a liquid as a specimen and an inspection liquid, materials forming the channel are required to have high hydrophobicity in order to prevent the liquid from blurring into the channel wall and to prevent the channel wall from swelling due to water absorption when the device is used in a high-humidity environment. In particular, the hydrophobicity of the side of the channel wall on the channel side is important and has a significant effect on the flow rate of the specimen and the blur into the channel wall.

In Japanese Patent Application Laid-Open No. 2015-131257, there is proposed a microchannel device in which a channel wall is formed in a porous substrate (such as paper) using a thermal transfer type printer. In this proposal, a channel wall is formed by filling a void in the porous substrate with a molten channel wall forming material by thermal compression. A thermoplastic material and fat (wax) are used as the channel wall forming material.

However, Japanese Patent Application Laid-Open No. 2015-131257 only discloses that the wax is evenly distributed inside the channel wall. When the amount of wax inside the channel wall is increased, the hydrophobicity of the channel wall becomes sufficient, but the flexibility of the channel wall is lost and the resistance to bending becomes low. On the contrary, when the amount of wax inside the channel wall is decreased, the flexibility of the channel wall becomes good and the resistance to bending becomes good, but the hydrophobicity of the channel wall tends to become insufficient. Therefore, when the amount of wax inside the channel wall is made evenly, the compatibility between the hydrophobicity and the resistance to bending becomes difficult. If the hydrophobicity of the channel wall is insufficient, there is a risk that a sample liquid will blur out of the channel, or a possibility that turbulence will occur in the sample liquid, which lead to decreased sensitivity due to a decrease in flow velocity.

Based on these circumstances, proposed is a microchannel device as the present disclosure that suppresses blur from the channel wall of the specimen or the inspection liquid which flow in the channel or decrease in sensitivity due to a change in flow velocity by forming the channel wall that is highly resistant to bending and maintains high hydrophobicity.

The object of the present disclosure is directed to provide a microchannel device with excellent resistance to bending and with suppressed deterioration in inspection accuracy.

### SUMMARY OF THE DISCLOSURE

A microchannel device that has a channel sandwiched between channel walls formed in an inside a porous substrate, the channel wall contains a thermoplastic resin and a wax, a proportion of the wax in an area of a surface side of the channel wall facing the channel is higher than a proportion of the wax in an internal area of the channel wall.

Further features of the present disclosure will become apparent from the following description of exemplary embodiments with reference to the attached drawings.

### BRIEF DESCRIPTION OF THE DRAWINGS

FIG. 1A is a cross-sectional diagram of a microchannel device before heating formed by permeating the porous substrate S1 with channel wall forming materials T1 to T3 (shown as T in the figure) in Examples 1 to 3.

FIG. 1B is a cross-sectional diagram of a microchannel device after heating formed by permeating the porous substrate S1 with a channel wall forming material T1 in Example 1.

FIG. 1C is a partially enlarged diagram of FIG. 1B.

FIG. 2 is a structural diagram of an image forming unit 100 according to Example 1.

FIG. 3 is a structural diagram of a process cartridge P according to Example 1.

FIG. 4 is a block diagram showing a schematic control mode of an image forming unit 100 according to Example 1.

FIG. 5A is a flow pattern diagram in Example 1.

FIG. 5B shows a cross-sectional diagram at the position of dashed line 80a in FIG. 5A.

FIG. 5C is a partial enlargement of FIG. 5B.

FIG. 6 is a cross-sectional diagram of the channel wall in Example 1.

### DESCRIPTION OF THE EMBODIMENTS

Embodiments of the disclosure will be described below with reference to the drawings. The following embodiment is an example, and the disclosure is not limited to the contents of the embodiment. In the following figures, components that are not necessary for the explanation of the embodiment are omitted from the figures.

In the microchannel device according to the present disclosure, a channel sandwiched by a channel wall is formed inside a porous substrate.

The channel wall contains a thermoplastic resin and a wax.

The proportion of the wax is higher in an area of a surface side of the channel wall facing the channel than in an internal area of the channel wall.

“A proportion of the wax” means a proportion of the area occupied by the wax when the cross section of the microchannel device is observed.

“A surface of the channel wall facing the channel” means the surface of the channel wall facing the channel, which is present inside the substrate.

“An internal area of the channel wall” means the inside of the channel wall which is not a porous substrate surface and does not face the channel wall.

When measuring “proportion of the wax”, a cross section is made across the channel and the channel wall. When measuring the proportion of the wax on the “surface side of the channel wall facing the channel,” the wax percentage on the channel side of the channel wall facing the channel as much as possible is measured. When measuring the proportion of wax on the “internal area of the channel wall,” the wax percentage on the channel wall far enough from the surface facing the channel wall and also far from the surface of the substrate is measured.

“A proportion of wax in an area of a surface side of the channel wall facing the channel is higher than the proportion of wax in the internal area of the channel wall” means that Y>X when X is the proportion of wax in a channel wall material internal area of the channel wall and Y is the proportion of wax in the channel wall material in the area facing the channel wall.

Based on the area from the channel wall material observed in the cross section of the microchannel device, X can be 3 to 20%, or 5 to 15%, and Y can be 25 to 95%, or 27 to 88%. In this case, both anti-bending performance and high inspection accuracy are better achieved.

The microchannel device of the present disclosure can be manufactured by, for example, electrophotography through the following processes.
(i) A latent image corresponding to the desired channel pattern is formed on the photosensitive member, and the latent image is developed using particles of the channel wall forming material.
(ii) The developed image is transferred to the surface of the porous substrate, and the channel pattern is formed on the porous substrate.
(iii) The channel pattern formed on the porous substrate is melted by heat to permeate into the inside of the porous substrate, and the channel wall is formed inside the porous substrate.

<Channel Wall Forming Material>

The channel wall forming material contains a thermoplastic resin and a wax (oil and fat).

The channel wall forming material is used to form a channel pattern on the surface of the porous substrate, and the channel wall forming material is permeated into the inside of the porous substrate to form the channel wall by melting the channel pattern by heat.

—Thermoplastic Resin—

Thermoplastic resin can be, but is not particularly limited to, an amorphous resin. For example, the following known thermoplastic resins can be used: Polyester resin, vinyl resin, acrylic resin, styrene-acrylic resin, polyethylene, polypropylene, polyolefin, ethylene-vinyl acetate copolymer resin, ethylene-acrylic acid copolymer resin, and the like.

In one embodiment, from among the thermoplastic resins, polyester resin or styrene-acrylic resin can be used, or, styrene-acrylic resin can be used.

A known polyester resin can be used as the polyester resin.

Specific examples of the method for producing the polyester resin include the following methods. A method for the dehydration condensation of a trivalent or more polybasic acid and their derivatives (carboxylic halides, esters, and acid anhydrides), monobasic acids, trivalent or more alcohols, monovalent alcohols, etc., where a dibasic acid or the derivative and a dihydric alcohol are essential.

Examples of dibasic acids include the following: aliphatic dibasic acids such as maleic acid, fumaric acid, itaconic acid, oxalic acid, malonic acid, succinic acid, dodecylsuccinic acid, dodecenylsuccinic acid, adipic acid, azelaic acid, sebacic acid, and decane-1,10-dicarboxylic acid, and the like; aromatic dibasic acids such as phthalic acid, tetrahydrophthalic acid, hexahydrophthalic acid, tetrabromphthalic acid, tetrachlorophthalic acid, chlorendic acid, hymic acid, isophthalic acid, terephthalic acid, and 2,6 naphthalenedicarboxylic acid; and the like.

In addition, examples of the dibasic acid derivatives include carboxylic acid halides, esters and acid anhydrides of the above-mentioned aliphatic and aromatic dibasic acids, and the like.

Meanwhile, the dihydric alcohol includes, for example, the following. Acyclic aliphatic diols such as ethylene glycol, 1,2-propanediol, 1,3-propanediol, 1,4-butanediol, 1,5-pentanediol, 1,6-hexanediol, diethylene glycol, dipropylene glycol, triethylene glycol, neopentyl glycol, and the like; bisphenols such as bisphenol A and bisphenol F, and the like; alkylene oxide adducts of bisphenol A such as ethylene oxide adducts of bisphenol A and propylene oxide adducts of bisphenol A, and the like; aralkylene glycols such as xylylene diglycol, and the like; and the like.

Examples of trivalent or high polybasic acid and anhydrides thereof include trimellitic acid, trimellitic anhydride, pyromellitic acid, pyromellitic anhydride, and the like.

Polymerizable monomers that can form the styrene-acrylic resin include the following. Styrene-based monomers such as styrene, α-methylstyrene and divinylbenzene; unsaturated carboxylic acid esters such as methyl acrylate, butyl acrylate, methyl methacrylate, 2-hydroxyethyl methacrylate, t-butyl methacrylate and 2-ethylhexyl methacrylate; unsaturated carboxylic acids such as acrylic acid, methacrylic acid; unsaturated dicarboxylic acids such as maleic acid; unsaturated dicarboxylic anhydrides such as maleic anhydride; nitrile-based vinyl monomers such as acrylonitrile; halogen-containing vinyl monomers such as vinyl chloride; nitro vinyl monomers such as nitrostyrene; and the like. These can be used alone or in combination of two or more.

When the styrene-acrylic resin forms a copolymer of a styrene-polymerizable monomer and an acrylate or methacrylate, a crosslinking agent may be added as required. Examples include the following.

Divinylbenzene, bis (4-acryloxypolyethoxyphenyl) propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, polyethylene glycol #200 diacrylate (CH₂═CHC(═O)O(CH₂CH₂O)₄C(═O)CH═CH₂, molecular weight 308), polyethylene glycol #400 diacrylate (CH₂═CHC(═O)O(CH₂CH₂O)₉C(═O)CH═CH₂, molecular weight 508), polyethylene glycol #600 diacrylate (CH₂═CHC(═O)O(CH₂CH₂O)₁₄C(═O)CH═CH₂, molecular weight 708), dipropylene glycol diacrylate, polypropylene glycol diacrylate, polyester-type diacrylate (MANDA Nippon Kayaku Co., Ltd.), and the above acrylates converted to methacrylate.

Crosslinkable monomers with three or more functions include the following. Pentaerythritol triacrylate, trimethylolethane triacrylate, trimethylolpropane triacrylate, tetramethylolethane tetraacrylate, oligoester acrylate and its methacrylate, 2,2-bis (4-methacryloxy polyethoxyphenyl) propane, diacrylic phthalate, triallyl cyanurate, triallyl isocyanurate, triallyl trimellitate and diaryl chlorenate.

An exemplary range of the weight average molecular weight (Mw) of the thermoplastic resin is 3,000 to 500,000, 5,000 to 300,000, or 7,500 to 100,000.

—Wax (Oil and Fat)—

The material used as the wax of the present disclosure is not particularly limited, and the following known waxes used for a toner can be used.

Esters of monohydric alcohols and aliphatic carboxylic acids, such as behenyl behenate, stearyl stearate and palmityl palmitate, or esters of monovalent carboxylic acids and aliphatic alcohols; esters of dihydric alcohols and aliphatic carboxylic acids, such as ethylene glycol dibehenate and hexanediol dibehenate; esters of divalent carboxylic acids and aliphatic alcohols, such as dibehenyl sebacate; Esters of trihydric alcohols and aliphatic carboxylic acids, such as glyceryl tribehenate, or esters of trivalent carboxylic acids and aliphatic alcohols; Esters of tetravalent alcohols and aliphatic carboxylic acids, such as pentaerythritol tetrastearate, pentaerythritol tetrapalmitate, or esters of tetravalent carboxylic acids and aliphatic alcohols; esters of hexavalent alcohols and aliphatic carboxylic acids, such as dipentaerythritol hexastearate, dipentaerythritol hexapalmitate, or esters of hexavalent carboxylic acids and aliphatic alcohols; esters of polyvalent alcohols and aliphatic carboxylic acids, such as polyglyceryl behenate, or esters of polycarboxylic acids and aliphatic alcohols; natural ester waxes, such as carnauba wax, rice wax; hydrocarbon wax (petroleum-based waxes such as paraffin wax, microcrystalline wax, petrolatum and their derivatives; wax by Fischer-Tropsch method and derivatives thereof; polyolefin wax such as polyethylene wax, polypropylene wax and derivatives thereof); higher aliphatic alcohol; fatty acids such as stearic acid and palmitic acid; acid amide waxes. These waxes may be used alone or in combination of two or more.

Among them, an ester compound of a diol having 2 to 6 carbon atoms and an aliphatic monocarboxylic acid having 14 to 22 carbon atoms can be used, or an ester compound of a diol having 2 carbon atoms and an aliphatic monocarboxylic acid having 14 to 22 carbon atoms can be used. The wax can be a hydrocarbon wax.

The content of the wax in the channel wall forming material can be 1.0 mass % to 25.0 mass %, or 3.0 mass % to 20.0 mass %. Being in the above range makes it possible to combine excellent low-temperature fixability with excellent heat-resistant storage. In one embodiment, the range is 5.0 mass % to 15.0 mass %.

The weight average molecular weight of the wax can be 300 to 10,000.

If the weight average molecular weight of the wax is less than 300, the permeability of the wax becomes too large and the blur from the surface side of the channel wall becomes large, and the channel wall may form inside the channel, narrowing the channel itself.

If the weight average molecular weight of the wax exceeds 10,000, the wax tends to stay inside the channel wall forming material, and the wax may not come out on the surface side of the channel wall facing the channel.

<Method for Calculating the Solubility Parameter (SP Value)>

The solubility parameter (SP value) is obtained using Fedors' equation (2). The values of Δei and Δvi below refer to “Evaporation energy and molar volume of atoms and groups (25° C.) as listed in Tables 3-9 of the Basic Science of Coatings, page 54˜57, 1986 (Maki Shoten).” The unit of SP value is (cal/cm³)^{1/2}, but it can be converted to the unit of (J/m³)^{1/2} by 1(cal/cm³)^{1/2}=2.046×10³(J/m³)^{1/2}.

δi=(Ev/V)^{1/2}=(Δei/Δvi)^{1/2} Equation (2)
Ev: Evaporation energy
V: Molar volume
Δei: Evaporation energy of i-component atoms or groups
Δvi: Molar volume of i-component atoms or groups

The SP value of the wax can be lower than that of the thermoplastic resin.
When the SP value of the wax is set to SP(W)(cal/cm³)^{1/2} and the SP value of the thermoplastic resin is set to SP(B)(cal/cm³)^{1/2}, the following equation (1) is satisfied.

SP(B)−SP(W)≥0.5 (1)
When the difference between the SP value of the resin and the SP value of the wax is 0.5 or less, the resin and the wax become miscible, the amount of wax in an area of a surface side of the channel wall facing the channel becomes insufficient, and the hydrophobicity of the channel wall may become insufficient. This may cause the sample to ooze out of the channel when it is dropped.

<Method for Measuring Molecular Weight Distribution and Peak Molecular Weight>

The molecular weight distribution and peak molecular weight are measured using gel permeation chromatography (GPC) as follows.
First, the measured sample is dissolved in tetrahydrofuran (THF). The obtained solution is filtered using a “MyshoriDisk” (manufactured by Tosoh Corporation) solvent-resistant membrane filter having a pore diameter of 0.2 μm to obtain a sample solution. The sample solution is adjusted to concentration of THF-soluble component of 0.8 mass %. Measurement is carried out under the following conditions using this sample solution.
Instrument: “HLC-8220 GPC” high-performance GPC instrument [manufactured by Tosoh Corporation]
Column: 2 columns of LF-604 [manufactured by Showa Denko Kabushiki Kaisha)
Eluent: THF
Flow rate: 0.6 mL/min
Oven temperature: 40° C.
Sample injection volume: 0.020 mL

A molecular weight calibration curve constructed to calculate the molecular weight of a sample, using a molecular weight calibration curve made with the following standard polystyrene resin. From the obtained molecular weight distribution, the largest peak in the obtained molecular weight distribution was taken to be the main peak, and the molecular weight value for this peak was designated the peak molecular weight.

Standard polystyrene resin: Trade name “TSK Standard Polystyrene F-850, F-450, F-288, F-128, F-80, F-40, F-20, F-10, F-4, F-2, F-1, A-5000, A-2500, A-1000, A-500” manufactured by Tosoh Corporation.

<Image (Channel Pattern) Forming Unit>

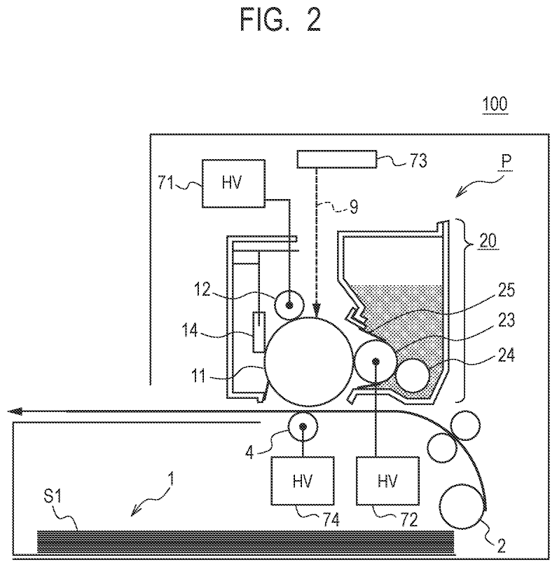

The overall configuration of the image forming unit will be described with reference to FIGS. 2, 3 and 4.

FIG. 2 shows the schematic configuration of the image forming unit 100 according to an example of the present disclosure in cross section, and each configuration is shown briefly.

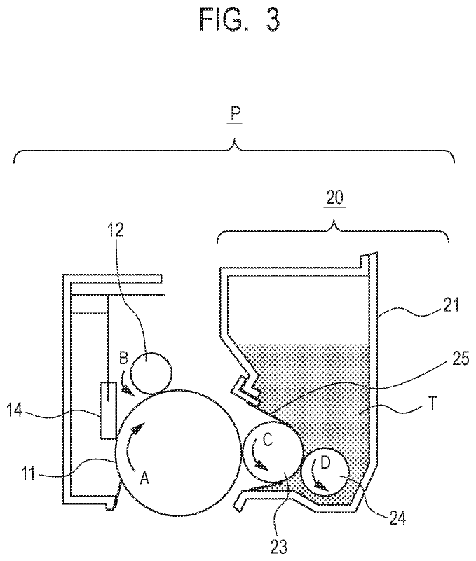

FIG. 3 is a schematic cross section of the process cartridge P according to an example of the present disclosure.

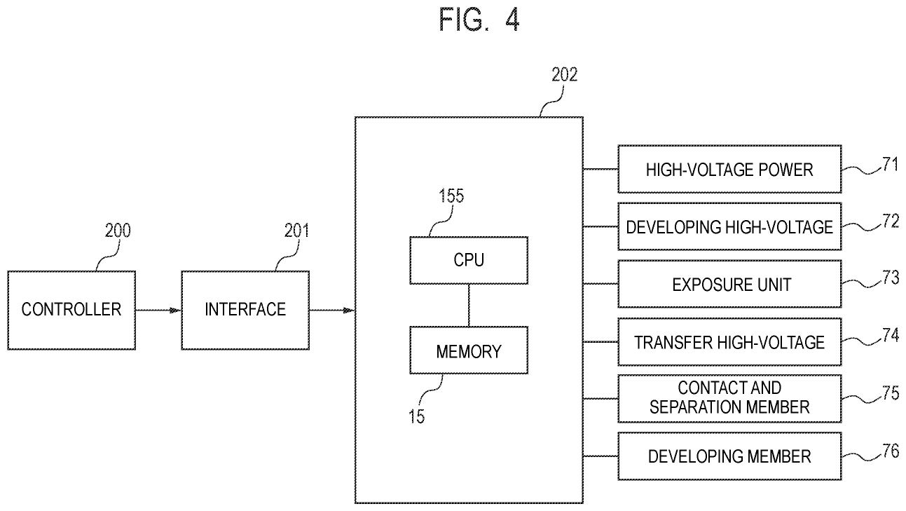

FIG. 4 is a block diagram showing the schematic control mode of the main part of the image forming unit 100 in this example.

First, the configuration of the image forming unit, the image forming process and each member will be described. With reference to FIG. 2, each member involved in the image forming process is described in order of the image forming process.

The image forming unit 100 accommodates a process cartridge P. The process cartridge P includes with a photosensitive drum 11 as an image carrying member. A charging roller 12 for charging the surface of the photosensitive drum 11, a developing apparatus 20 for developing an electrostatic latent image formed on the surface of the photosensitive drum 11 by a developer (a channel wall forming particle), and a cleaning member 14 for cleaning a surface of the photosensitive drum 11 are provided around the photosensitive drum. The developing apparatus 20 has a developing container 21 and a developing blade 25. A voltage necessary for forming the image can be applied by a charging high-voltage power source 71, a developing high-voltage power source 72, and a transferring high-voltage power source 74, and is controlled by a control unit 202 (FIG. 4).

When image formation begins, the surface of the photosensitive drum 11 is uniformly charged to −460 V by applying a voltage of −946 V to the charging roller 12 as charging for image formation. A DC (direct current) voltage is applied to the charging roller 12, and the photosensitive drum 11 is uniformly charged with the charging potential Vd by discharge. Vd in this case is called dark potential and is −460 V.

After the surface of the photosensitive drum 11 has been charged by the charging roller 12, the surface of the photosensitive drum 11 is irradiated with a laser light 9 emitted from an exposure unit 73. The surface of the photosensitive drum 11 irradiated with the laser light 9 changes its surface potential to −100 V as V1, which is a light portion potential, and the electrostatic latent image is formed.

As shown in FIG. 4, into the exposure unit 73, time-series electric digital pixel signals of an image information are input which has been input into the to the control unit 202 from the controller 200 via an interface 201, and has been subjected to image processing therein. The control unit 202 includes a CPU 155 that is a central element for performing various arithmetic processes, and a memory 15 such as a ROM and a RAM which are storage elements.

The exposure unit 73 includes a laser output unit that outputs the laser beam 9 modulated so as to correspond to the time-series electrical digital pixel signals to be input, a rotating polygon mirror (polygon mirror), an fθ lens, and a reflecting mirror; and subjects the surface of the photosensitive drum 11 to main scanning exposure by the laser beam 9. Due to this main scanning exposure and sub-scanning by the rotation of the photosensitive drum 11, the electrostatic latent image corresponding to the image information is formed.

<Image (Channel Pattern) Forming Process>

The image forming unit 100 has a contact/separation means 75 for controlling the position of the developing apparatus 20, and can control the position of the developing apparatus 20 to different positions at the time when the image is formed and at the time when the image is not formed. An operation of the contact/separation means 75 is controlled by the control section 202 shown in FIG. 4.

After the photosensitive drum 11 has started rotating, the developing apparatus 20 moves a developing roller 23 of a developer bearing member by the contact/separation unit 75, which has been separated from the photosensitive drum 11, so as to come into contact with the photosensitive drum 11.

Subsequently, the developing roller 23 starts rotating in the direction of the arrow C in FIG. 3, and supplying roller 24 of developer (channel wall forming material) supplying member starts rotating in the direction of arrow D in FIG. 3, by the driving of motors M2 (unillustrated) which are connected to the rollers, respectively. Then, due to a voltage of −300V, which is applied as the developing voltage from the developing high-voltage power source 72 for the developing roller 23 to the developing roller 23, the developer is supplied by the developing roller 23 to the electrostatic latent image that is formed on the photosensitive drum 11, in other words, the above V1 portion, and the electrostatic latent image is developed. For information, a ratio between a moving velocity of the surface of the photosensitive drum 11 and a moving velocity of the surface of the developing roller 23 (moving velocity of surface of developing roller 23/moving velocity of surface of photosensitive drum 11) at this time is referred to as a developing peripheral speed ratio. An amount of the developer to be developed on the photosensitive drum 11 can be controlled by the control of the developing peripheral speed ratio with a developing peripheral speed 76 illustrated in FIG. 4. For example, if the developing peripheral speed ratio is 2.5, in a case where all the developer on the developing roller 23 is are used to develop the electrostatic latent image on the photosensitive drum 11, the amount of the developer per unit area on the surface of the photosensitive drum 11 becomes 2.5 times the amount of the developer per unit area on the surface of the developing roller 23. In Examples described later, the developing peripheral speed ratio is controlled so that a developer amount suitable for forming a channel wall in the inside of the porous substrate S1 can be developed to the photosensitive drum.

The porous substrate S1 is placed on the paper feed tray 1 and picked up one by one by a pickup roller 2. The developed developer image (channel pattern) is transferred to the porous substrate S1 by the potential difference with the transfer roller 4 to which +2000 V is applied by the transferring high-voltage power source 74. The transfer roller 4 uses a semiconducting sponge consisting mainly of NBR hydrin rubber whose conductive axial core (hereafter, it is also referred to as core metal.) and pressure contact part to the photosensitive drum 11 are elastic bodies, and resistance adjustment is carried out using an ion conductive material. The outer diameter is 12.5 mm and the core metal diameter is 6 mm.

The porous substrate S1 onto which the developer image has been transferred is discharged to the outside of the image forming unit with keeping the developer image on the upper side in the gravity direction. The untransferred developer photosensitive drum 11 after passing through the transfer roller 4 is scraped off by an abutting cleaning member 14. A series of processes from the charging by the charging roller 12 is repeated to continuously form the image.

<Heating Process>

The porous substrate S1 onto which the channel pattern is transferred undergoes a heating process by means of a heating unit (unillustrated). By undergoing the heating process, the channel wall forming material melts, the melted material permeates into the porous substrate S1, and a hydrophobic channel wall is formed.

Therefore, the heating temperature need to controlled to a temperature at which the channel wall forming material melts and the melted material permeates into the porous substrate S1. In configurations of the Examples described later, the channel wall forming material permeated into the porous material S1 at temperatures above 140° C. or higher.

The heating time is required requires during which a molten channel wall forming material completely permeates through the thickness direction of the porous substrate S1, but if the heating time is too long, there is a possibility that the channel wall material results in diffusing more than necessary, and channel 82 after the heating process becomes thin, as compared with that of the formed channel pattern. In configurations of examples, an appropriate channel wall could be formed by setting the heating time set to 1 to 10 minutes.

In view of the above, the heating conditions in the examples described later were set to 2 minutes in a 200° C. environment. An oven (Yamato Science Co., Ltd., air blowing constant-temperature incubator DN610H) was used as the heating unit. However, the heating method is not limited to this, a far infrared heater or a hot plate or the like may be used; and the heating conditions should be selected according to the physical properties of the channel wall forming material and the porous substrate S1.

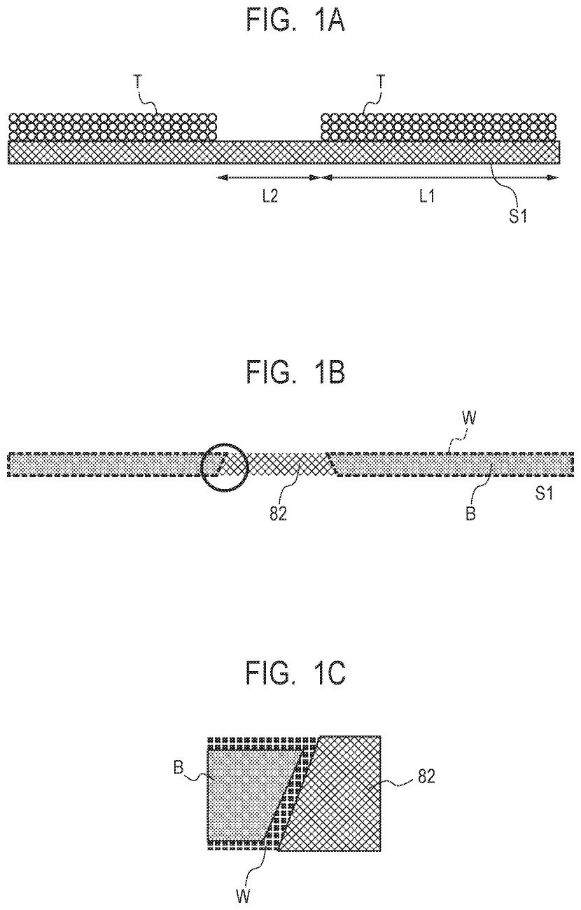

The heating process under the above conditions will be described with reference to FIGS. 1A and 1B.

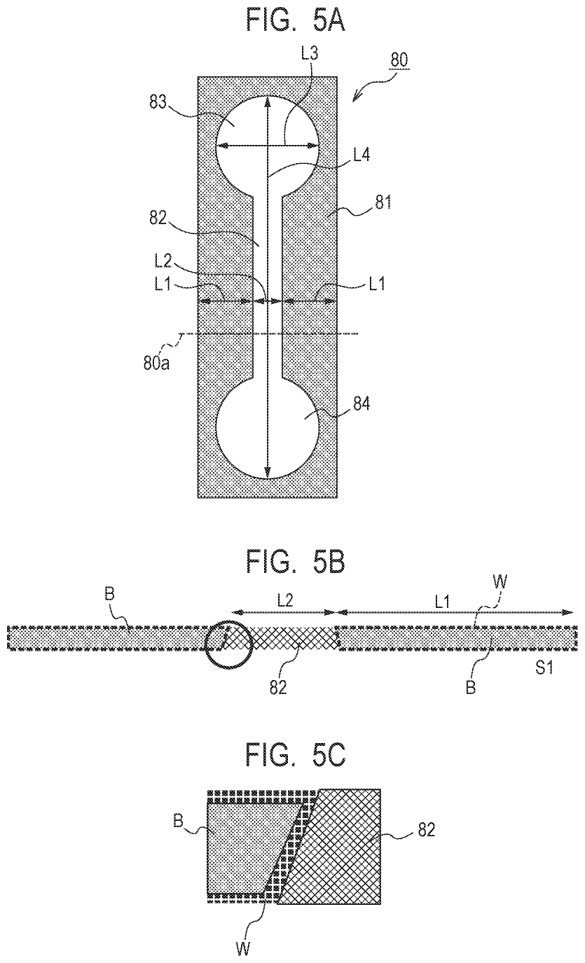

A schematic cross-sectional view taken at the position of dashed line 80a in FIG. 5A is illustrated in FIGS. 1A and 1B, as a view illustrating the channel wall forming material before and after heating. FIG. 1A is a cross-sectional view before heating and FIG. 1B is a cross-sectional view after heating. FIG. 1C is an enlarged view of a portion of FIG. 1B.

The channel wall forming material before heating is simply adhered to the surface of the porous substrate S1 as illustrated in FIG. 1A. The channel wall forming material is melted by subsequent heating and the melted channel wall forming material permeates into the inside of the porous substrate S1 by capillary phenomenon with the porous substrate S1 to form the channel wall as illustrated in FIGS. 1B and 1C. Thus, the microchannel device having channel 82 sandwiched between the channel walls formed in an inside of the porous substrate is obtained.

<Channel>

A channel is an area of a porous substrate sandwiched by channel walls (details will be described below.) and is an area where a sample liquid flows by capillary phenomenon.

In examples described below, the channel pattern 80 illustrated in FIG. 5A was formed on the porous substrate S1 using the channel pattern imaging unit 100.

FIG. 5B illustrates a cross-sectional schematic view at the position of the dashed line 80a in FIG. 5A. FIG. 5C is an enlarged view of a portion in FIG. 5B.

To use as a microchannel device, the channel wall forming particle portion 81 surrounding each of the reagent portion 83, the test solution portion 84 and the channel 82 was formed. The reagent portion 83 is the area for attaching the reagent, the test solution portion 84 is the area for attaching the test solution (sample liquid), and the channel 82 is connecting the reagent portion 83 and test solution portion 84. The channel wall forming particle portion 81 sandwiching the channel 82 had a width L1 of 4 mm, and the channel 82 had a width L2 of s 1.5 mm. The diameter L3 of the test solution portion 84 was 7 mm, and the longest part L4 of the channel was 40 mm. As an example of use as a microchannel device is that by attaching a chemical showing a coloration reaction to the reagent portion 83 and attaching a test solution to the test solution portion 84, the test solution can be diffused through the channel 82 to the reagent portion 83 and then whether a coloration reaction occurs. However, the shape and size of the channel pattern are not, of course, limited to this, and the shape may be a combination of straight lines, curves, and use branching, and the width of the channel may be changed in the middle of the channel.

<Channel Wall>

The channel wall is composed of the above channel wall forming material and has high hydrophobicity. In particular, in order to function as a channel, it is important that the surface (side surface) of the channel wall has high hydrophobicity, and by increasing the hydrophobicity, the flow rate of the specimen can be increased and the blur into the channel wall can be suppressed.

In order to increase the hydrophobicity of the surface of the channel wall that faces the channel, it is effective to increase the proportion of wax in the area.

When forming the channel pattern on the surface of the porous substrate, a developer (particles for forming the channel wall) with different amounts of wax can be used in the area that faces the channel and an internal area of the channel wall. Specifically, a developer with a large amount of wax is used as the developer for forming the area that faces the channel (for example, about 1 mm width), and a developer with a small amount of wax or containing no wax is used as the developer for forming the area that is the internal area of the channel wall. When the channel wall is formed using such a channel pattern, the amount of wax at the surface and the vicinity of the microchannel device can be reduced while ensuring sufficient hydrophobicity of the surface of the channel wall that faces the channel. Other layers and members, such as protective layers and electrodes, may be layered on the surface of the microchannel device, and the amount of wax at the surface and the vicinity thereof can be reduced to prevent the layered members from peeling off.

That is, the proportion of wax in an area of a surface side of the channel wall facing the channel can be higher than the proportion of wax in an area X specified as follows (the area X is an area, which does not face the channel of the channel wall, and of the surface of the porous substrate and the vicinity thereof). Furthermore, the proportion of wax in the area X can be 15% or less, or it can be 7% or less.

<Porous Substrate>

It is preferable for the porous substrate S1 to show an appropriate void ratio and hydrophilicity. An open-cell bubble structure and a network (nanofiber or the like) structure are satisfactory as the porous structure, and examples thereof include filter paper, plain paper, high-quality paper, watercolor paper, Kent paper, synthetic paper, a porous film of a synthetic resin, fabric, and fiber products. Among the examples, filter paper can be used from the viewpoint of having high void ratio and satisfactory hydrophilicity.

The void ratio can be appropriately selected according to the purpose, for instance, 20% to 90%. If the void ratio exceeds 90%, the strength as a substrate may not be maintained, and if the void ratio is less than 20%, the permeability of the sample liquid may deteriorate.

The hydrophilicity of the substrate is a necessary property for a water-containing biological fluid of the sample liquid such as blood, urine and saliva to be capable of diffusing into the substrate.

The average thickness of porous substrates from 0.01 mm to 0.3 mm is often used. If the average thickness is less than 0.01 mm, the strength of the substrate may not be maintained. Depending on the application, a thick one with a thickness of about 0.6 mm may be used, but the present disclosure is also suitable in such a case because the channel wall is made on a thick porous substrate. Therefore, the average thickness of the porous substrate used in the present disclosure can be 0.01 mm to 1.0 mm.

The apparent density (g/cm³) is calculated as (basis weight (g/m²)/thickness (mm)×1000) and the void ratio (%) is calculated as ((true density−apparent density)/true density×100).

Table 1 shows the basis weight of the porous substrate S1 used in the examples described below.

TABLE 1

| | Basis | | Apparent | True | |
|---|---|---|---|---|---|
| | weight | Thickness | density | density | Void ratio |
| substrate | (g/m²) | (mm) | (g/cm³) | (g/cm³) | (%) |
| S 1 | 55 | 0.08 | 0.69 | 1.5 | 54 |

<Section of Channel Wall>

A channel wall forming material includes thermoplastic resin and wax. In this example, a channel wall is formed on the porous substrate S1 by melting the channel wall forming material by heat through the heating process as described above and permeating into the porous substrate S1. In the configuration of the example described below, wax W comes out to the outside of the channel wall as illustrated in FIG. 1C. This is because the difference in surface free energy between thermoplastic resin B and wax W makes it easier for wax W with a lower SP value to exist in an area of a surface side of the channel wall facing the channel on the channel 82 side.

Wax W also has a faster permeation rate in the capillary phenomenon to the porous substrate, which makes it easier to cover the outside of the channel wall. Therefore, as illustrated in FIG. 1C, the presence ratio of wax Won the side of the channel 82 side increases. This improves the hydrophobicity of the channel wall and reduces the risk of solution, such as a specimen, blurring outside the channel 82 (inside the channel wall).

In addition, the larger the difference between the SP value of the resin and the SP value of the wax, the easier it is for the wax to move to the face side (outer edge) of the channel wall facing the channel.

### EXAMPLES

The disclosure will be described in detail below with examples and comparative examples, but the disclosure is not limited to these examples. “Part” and “%” in the text are mass standards unless otherwise noted.

### Example 1

In Example 1, a microchannel device was produced under the aforementioned conditions using a channel wall forming particle T1 containing a thermoplastic resin B1 (amorphous resin) and a wax W1.

The channel wall forming particle T1 were produced by suspension polymerization as follows.

[Preparation of Polymerizable Monomer Composition]

| | |
|---|---|
| Styrene | 70.0 parts by mass |
| N-butyl acrylate | 30.0 parts by mass |
| Divinylbenzene | 0.3 parts by mass |
| Wax W1 (ethylene glycol dibehenate) | 12.0 parts by mass |

The above materials were kept at 65° C. and polymerizable monomer composition was prepared by dissolving and dispersing uniformly at 500 rpm using T. K Homomixer (manufactured by Specialty Mechanization Industries, Ltd.).

[Preparation of Dispersion Stabilizer]

Ion-exchanged water 710 parts and 0.1 mol/L sodium phosphate aqueous solution 450 parts were added to a 2-L four-neck flask fitted with a high-speed stirring device T.K. Homomixer (manufactured by PRIMIX Corporation) and heated to 60° C. while stirring at a speed of 12000 rpm. To this, 68.0 parts of 1.0 mol/L calcium chloride aqueous solution was added and, an aqueous dispersion medium containing a poorly water-soluble dispersion stabilizer (calcium phosphate) was prepared.

[Granulation and Polymerization]

The polymerizable monomer composition was put into the above aqueous dispersion medium and granulated for 15 minutes while the rotation speed was maintained at 12000 rpm. Then, the agitator was changed from the high-speed agitator to the propeller agitator blade, and the internal temperature was raised to 60° C. and maintained at 60° C. to continue the polymerization reaction for 5 hours. Furthermore, the internal temperature was raised to 80° C. and maintained at 80° C. to continue the polymerization reaction for 3 hours. After the polymerization reaction was completed, the remaining monomer was distilled off at 80° C. under reduced pressure, and then cooled to 30° C. to obtain a polymer fine particle dispersion.

[Wash]

The above polymer fine particle dispersion was transferred to a container for washing, and while stirring, dilute hydrochloric acid was added to adjust the pH to 1.5. After stirring the dispersion for 2 hours, the polymer fine particles were obtained by solid-liquid separation with a filter. The obtained were put into 1200 parts of ion-exchanged water and stirred to make the dispersion again, followed by solid-liquid separation with a filter. This operation was performed 3 times to obtain parent particles of the channel wall forming particle T1.

[External Addition of Fluidity Enhancer]

To 100.0 parts of the obtained parent particles, 1.0 parts of a fluidity enhancer (silica with a primary particle number average particle size of 7 nm) surface-treated with hexamethyldisilazane were dry-mixed for 5 minutes in a Henschel mixer to obtain the channel wall forming particle T1 with a weight average particle size (D4) of 6.8 μm.

### Example 2

In Example 2, the microchannel device was produced in the same manner as in Example 1 except that a channel wall forming particle T2 was used.

The channel wall forming particle T2 was produced using the following thermoplastic resin B2 and a wax W2 by the grinding method (produced by kneading and grinding the material). The weight average particle size was 7.0 μm.
Thermoplastic resin B2 (amorphous resin): A polyester resin synthesized using bisphenol A-PO 2 mol adduct and bisphenol A-EO 2 mol adduct as diol components and terephthalic acid as dicarboxylic acid component 100 parts by mass
Wax W2 (“FNP 90” manufactured by Nippon Seiro Co., Ltd.) 10 parts by mass

The producing conditions by the grinding method are shown as follows. The above thermoplastic resin B2 and wax W2 were blended at 120° C. using a biaxial mixer (PCM Type-30, manufactured by Ikegai Co., Ltd.) to obtain a kneaded product. The resulting kneaded product was cooled and coarsely ground to less than 1 mm by a hammer mill to obtain a coarsely ground product. The obtained coarsely ground product was finely ground by a mechanical grinder (T-250, manufactured by Turbo Industry, Inc.). Further classification was carried out by using a rotary classifier (200TSP, manufactured by Hosokawa Micron Co., Ltd.) under classification conditions at a classification rotor speed of 50.0 s⁻¹ to obtain the channel wall forming particle T2.

### Example 3

In Example 3, the microchannel device was produced in the same manner as in Example 1 except that a channel wall forming particle T3 were used.
The channel wall forming particles T3 were produced in the same manner as the channel wall forming particles T2, except that a wax W3 (HNP9: manufactured by Nippon Seiro Co., Ltd., paraffin wax) was used instead of the wax W2. The weight-average particle size (D4) of the obtained channel wall forming particle T3 was 7.1 μm.

### Comparative Example 1

In Comparative Example 1, the microchannel device was produced in the same manner as Example 1 except that a channel wall forming material particle T4 were used.
The channel wall forming material particle T4 were produced in the same manner as the channel wall forming particle T1 except that the wax W1 was not used. The weight average particle size (D4) of the obtained channel wall forming particle T4 was 7.2 μm.

Table 2A shows the resin type and the SP values, wax type, the SP values and the weight average molecular weight, and ΔSP value used in Examples 1 to 3 and Comparative Example 1. Table 2B also shows the percentage of wax in the microchannel devices manufactured in Examples 1 to 3 and Comparative Example 1.

TABLE 2A

| | | | | | Oil and fat (wax) | | | | |
|---|---|---|---|---|---|---|---|---|---|
| | | | | | | | | Weight | |
| | | | | | | | | average | |
| | Channell wall | Thermoplastic Resin | | | | | SP | molucular | |
| | forming | | | SP value | | | value | weight | ΔSP |
| | particle | Resin material | | SP(B) | Wax | | SP(′W) | (Mw) | value |
| Example 1 | T 1 | B 1 | Styrene- | 9.80 | W 1 | Ethylene glycol | 8.81 | 707 | 0.99 |
| | | | acrylic resin | | | dibehenate | | | |
| Example 2 | T 2 | B 2 | Polyester | 10.54 | W 2 | FNP90 | 8.39 | 771 | 2.15 |
| | | | resin | | | | | | |
| Example 3 | T 3 | B 2 | Polyester | 10.54 | W3 | H N P 9 | 8.28 | 469 | 2.26 |
| | | | resin | | | | | | |
| Comparative | T 4 | B1 | Styrene- | 9.80 | — | | | | |
| Example 1 | | | acrylic resin | | | | | | |

The unit of SP value in Table 2A is (cal/cm³)^{1/2}.

TABLE 2B

Proportion of wax

| | Inside of | Area of face side of |
|---|---|---|
| | channel wall | channel wall facing channel |
| Example1 | 15% | 27% |
| Example 2 | 10% | 55% |
| Example 3 | 9% | 88% |
| Comparative | not inspected | not inspected |
| Example 1 | | |

[Performance Evaluation of Microchannel Device]

As a performance evaluation of the microchannel devices produced using the channel wall forming materials of Examples 1 to 3 and Comparative Example 1, 0.05 mL of water was dropped into the reagent portion 83 shown in FIG. 5A, and the time required for water to permeate the entire channel was measured. The shorter the time, the smoother the liquid progress can be made by suppressing the leakage when the test solution is injected and improving the water repellency of the channel wall in the channel.

Table 3 shows the results of the permeation time of the microchannel device of Examples 1 to 3 and Comparative Example 1.

TABLE 3

| | Channel wall forming | Required time to fill the |
|---|---|---|
| | particle | entire channel (s) |
| Example 1 | T1 | 260 |
| Example 2 | T2 | 245 |
| Example 3 | T3 | 225 |
| Comparative | T4 | 290, a slite blur |
| Example 1 | | |

As shown in Table 3, the microchannel device produced with the channel wall forming material of Comparative Example 1 without wax components took 290 seconds to fill the entire channel with water. In addition, when the channel wall was magnified and observed with an optical microscope after filling with water, it was confirmed that there was a slight blur.

In contrast, in the microchannel device produced using the channel wall forming material in Example 1, the entire channel was filled with water in 260 seconds, and water permeated 30 seconds faster than in Comparative Example 1.

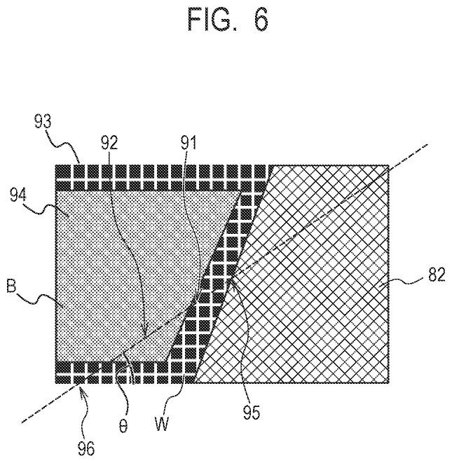

This indicates that in Example 1, a highly hydrophobic wax is present at the position of channel wall W shown in FIG. 6, the channel device blocks the water flowing into channel 82 and allows fluid to flow more efficiently without blur.

In Example 2, a microchannel device was produced using a channel wall forming material with a higher SP value difference between a thermoplastic resin and a wax than in Example 1. In Example 2, it took 245 seconds for water to fill the entire channel, and water permeated 15 seconds faster than in Example 1.

In addition, it was confirmed that the amount of the wax in the area of the side of the channel wall facing the channel (the position of W in FIG. 6) was larger in Example 2 than in Example 1 as observed by the following “measurement method for a wax in the channel wall section”. In other words, it was confirmed that a more hydrophobic channel device could be made by using a channel wall forming material containing a thermoplastic resin and wax with a large SP value difference as in Example 2.

Furthermore, in Example 3, a microchannel device was made using a channel wall forming material with a larger SP value difference between the thermoplastic resin and the wax than in Example 2. The weight average molecular weight (Mw) of the wax W3 is smaller than that of the wax used in Examples 1 and 2. In Example 3, in the performance evaluation, the time required for water to fill all the channels was shortened to 225 seconds.

<Measurement Method for Wax in Channel Wall Section>

In the present disclosure, an electronic dyeing method is used in which the difference in the microstructure between the crystalline phase (wax) and the amorphous phase (thermoplastic resin) is utilized to enhance the electron density of one component by heavy metals to provide contrast between materials.

Specifically, a channel device modified by an osmium tetroxide (OsO₄) is cured in a light-curable epoxy resin. Then, from the cured product, using an ultramicrotome equipped with a diamond knife (UC7, manufactured by Leica), a thin sample of 500 μm square and 20 μm thick is cut in an oblique direction (dashed line direction in FIG. 6, angle θ) so that the channel wall sections of 91 and 92 in FIG. 6 of the channel device can be observed.

Then, electronic staining is performed in conjunction with ruthenium tetroxide (RuO₄).
Specifically, using a vacuum electronic dyeing device (VSC4R1H manufactured by Filgen), a flaked sample is placed in a chamber, and the dyeing process is performed in a RuO₄ gas atmosphere at 500 Pa for a dyeing time of 15 min. The stained sample is magnified at a magnification of 10,000 times using the scanning image mode of a scanning transmission electron microscope (JEM2800, JEOL), and an image of the area W on the facing side of the channel wall, the image of the channel wall interior B is an image of the area W of the facing side of the channel wall facing the channel in the cross section of the channel device of FIG. 6 is obtained.

The scanning transmission electron microscope (STEM) has a probe size of 1 nm and an image size of 2048 pixels by 2048 pixels, and an image of the cross section was acquired at an acceleration voltage of 200 KV.

The identification of wax in the cross section image was carried out using an energy dispersive X-ray spectrometer (EDX), etc.

The measurement of the proportion of wax in the area of the facing side of the channel wall facing the channel was carried out from the channel side, and the position where the wax components started to be detected (0 point; 95 in FIG. 6) was taken for a 10 μm square at position 91 advancing 20 μm toward 96.
We chose 20 μm because the condition of the channel wall 20 μm from the interface where the specimens comes into contact with the channel side of the channel wall affects the velocity of the specimen flowing through the channel as a water-repellent effect of the channel wall.
Samples whose distance from point 0 (95 in FIG. 6) to the substrate surface 96 is 200 μm or more are to be measured.
Since the amount of the wax area stained by ruthenium tetroxide (RuO₄) is different from the surrounding resin (94 in FIG. 6), the contrast becomes clear and the wax area can be easily identified.
In addition, the measurement of the proportion of the wax inside the channel wall was carried out for a 10 μm square at a position more than 20/cos θ (μm) away from the above 96 toward point 0 and more than 10 μm away from the surface of the porous substrate.

Furthermore, regarding the proportion of the wax in an area X (an area, which does not face the channel of the channel wall, and of the surface of the porous substrate and the vicinity thereof), the proportion of the wax in the area from the surface of the porous substrate to a depth of 10 μm was used.

And, in all cases, the proportion of the wax is calculated using the following equation (3), where C is the area occupied by the channel wall forming material (The wax is included. The porous substrate is not included.) and D is the area occupied by the wax.

The proportion of the wax=D/C×100 (3)

<Hydrophobicity Checking Contact Angle of Channel Device>

The contact angle of the surface of the microchannel device produced in Example 1 to water was measured using a CA-W type contact angle measuring device (manufactured by Kyowa Interface Science Co., Ltd.).
The wax was present on a surface 93 shown in FIG. 6 and the contact angle was 120 degrees.

Moreover, the contact angle of the surface to water was 100 degrees when measured after the wax component of the surface 93 was dissolved with hexane and removed from the surface. Generally, a higher contact angle indicates a higher water repellency, and this result also indicates that the water repellency of the surface side of the channel wall is higher than that of the inside of the channel wall. Therefore, the surface of the channel wall where the specimen in the channel meets (the interface between the channel and channel wall) is also considered to be highly water repellent.

In addition, the bending resistance of the obtained microchannel devices were confirmed, and all the devices showed good bending resistance.

<About the Method for Producing>

As described above, by using an electrophotographic method, a channel wall forming material containing a thermoplastic resin and a wax with an SP value lower than that of the thermoplastic resin is placed on the surface of a porous substrate to form a channel pattern, which is then melted by heat to form a channel for a microchannel device, the presence ratio of wax in the surface side area of the channel wall facing the channel increases, and the hydrophobicity of the channel wall is enhanced. Therefore, it is possible to reduce the risk of the specimen blurring into the channel wall and to produce a stable microchannel device that can advance the specimen more efficiently by capillary phenomenon.

### Example 4

A channel wall forming particle T5, in which the amount of wax in the channel wall forming particle T3 was changed to 15 parts by mass, and channel wall forming particle T6, in which the amount of wax in the channel wall forming particle T3 was changed to 7 parts by mass, were prepared.

In the channel pattern formed on the surface of the porous substrate, the channel wall forming particle T5 was used in the area of 1.0 mm width on the channel side of the area to be the channel wall, and the channel wall forming particle T6 was used in the other parts of the area to form the channel wall. Then, by heating, the formed channel pattern was permeated into the porous substrate to produce the microchannel device.

In addition to the formation of channel walls with excellent hydrophobicity, the fabricated microchannel device had a small amount of surface wax, and could cope well with a configuration in which other layers and members were layered.

### Example 5

The channel wall forming resin particle T5, in which the amount of wax in the channel wall forming resin particles T3 was changed to 15 parts by mass, and a channel-wall forming resin particle T7, in which the amount of wax in the channel wall forming resin particle T1 was changed to 3 parts by mass, were prepared.

In the channel pattern formed on the surface of the porous substrate, the channel wall forming particle T5 were used in the area of 1.0 mm width on the channel side of the area to be the channel wall, and the channel wall forming particle T7 was used in the other parts of the area to form the channel wall. Then, by heating, the formed channel pattern was permeated into the porous substrate to produce the microchannel device.

The produced microchannel device, whose channel wall with excellent hydrophobicity was formed, and the amount of wax on the surface was even less than that of the device produced in Example 4, and was therefore better able to cope with the configuration of overlapping other layers and members.

TABLE 4

| | Presence proportion of wax | | |
|---|---|---|---|
| | | Area of surface | Surface of pourous |
| | Inside of | side of channel wall | material of channel wall |
| | channel wall | facing channel | and vicinity thereof |
| Example 4 | 5% | 95% | 15% |
| Example 5 | 3% | 95% | 8% |

According to the present disclosure, it is possible to provide a microchannel device with excellent resistance to bending and with suppressed deterioration in inspection accuracy

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. A microchannel device that has a channel sandwiched between channel walls formed in an inside a porous substrate,
the channel wall contains a thermoplastic resin and a wax,
wherein a proportion of the wax in an area of a surface side of the channel wall facing the channel is higher than a proportion of the wax in an internal area of the channel wall.

2. The microchannel device according to claim 1, wherein a SP value of the wax is lower than a SP value of the thermoplastic resin.

3. The microchannel device according to claim 1, wherein
when the SP value of the wax is set to SP(W) (cal/cm³)^{1/2} and the SP value of the thermoplastic resin is set to SP(B) (cal/cm³)^{1/2}, the formula (1) is satisfied:
SP(B)−SP(W)≥0.5 (1).

4. The microchannel device according to claim 1, wherein the weight average molecular weight of the wax is 300 to 10,000.

5. The microchannel device according to claim 1, wherein the proportion of the wax in the area of the surface side of the channel wall facing the channel is higher than the proportion of the wax in an area X satisfying the following specification:
wherein the area X is an area, which does not face the channel of the channel wall, and of the surface of the porous substrate and the vicinity thereof.

6. The microchannel device according to claim 5, wherein the proportion of the wax in the area X is 15% or less.

7. The microchannel device according to claim 5, wherein the proportion of the wax in the area X is 7% or less.

8. A method for producing a microchannel device that has a channel sandwiched between channel walls formed in an inside a porous substrate, comprising:
placing a channel wall forming material containing a thermoplastic resin and a wax on a surface of the porous substrate by an electrophotographic method to form a channel pattern on the surface of the porous substrate; and
melting the channel wall forming material by heat to allow the channel wall forming material to permeate into the inside of the porous substrate, thereby forming the channel wall in the inside of the porous substrate,
wherein a SP value of the wax is lower than a SP value of the thermoplastic resin.
